(19) United States
(12) Patent Application Publication
(10) Pub. No.: US 2013/0226817 A1
(43) Pub. Date: Aug. 29, 2013

(54) METHOD FOR AN INVENTOR AND PATENT AGENT TO COLLABORATE IN PREPARAING A PATENT APPLICATION

(71) Applicant: Harold W. Milton, JR., Bloomfield Hills, MI (US)

(72) Inventor: Harold W. Milton, JR., Bloomfield Hills, MI (US)

(21) Appl. No.: 13/403,024

(22) Filed: Feb. 23, 2012

(51) Int. Cl. G06Q 50/18

(52) U.S. Cl. 705/310

(57) ABSTRACT

A processing center establishes a link over the internet between the inventor and an independent the patent agent structuring a set of claims and partial sections of a patent application to be returned by the processing center to the inventor for final editing. The picture claim is copied into the description and old elements before a coded phrase in the broad is copied into the prior art section while the new element after the coded phrase are copied into the summary section; all of which is returned by the processing center to the inventor combined with an inventor-computer word processing program for editing by the inventor. The inventor-computer word processing program is tied to the set of claims for preventing use of the inventor-computer word processing program with other documents. The processing center assigns subject matter classification numbers to inventor disclosures and to patent agents for avoiding a conflict by a patent agent.

### BACKGROUND OF THE INVENTION

1. Field of the Invention

A method for an inventor and patent agent to collaborate in preparing a patent application.

2. Description of the Prior Art

The inventor named herein has made known a method for preparing a patent application wherein imbedding a template setting forth sections of a patent application in a patent computer program for drafting a broad claim reciting a novel limitation after a coded phrase with supporting old limitations before the coded phrase and successive claims dependent on the broad claim with each dependent claim reciting a novel limitation and an independent picture claim containing all of the same verbiage used in the broad and dependent claims. The patent computer program is operated to recognize the coded phrase and to copy the supporting old limitations before the coded phrase of the broad claim into the prior art section of the template while coping a novel limitation after the coded phrase of the broad claim into the summary section of the template. The program also copies the entire picture claim into the description section of the template. Such systems and a word processing computer program for preparing a patent application are disclosed in the following United States Patents and applications: U.S. Pat. No. 7,890,851, granted Feb. 15, 2011 in class 715, sub-class 224; Publication Number 2007/0136321, Jun. 14, 2007 class 715, in class 707, sub-class 100; Publication Number 2008/0178114, Jul. 24, 2008 in class 715, sub-classes 200, 779 and 810; Publication Number 2008/0256428, Oct. 16, 2008 in class 715, sub-class 200; Publication Number 2009/0132899, May 21, 2009 in class 715, sub-class 200; Publication Number 2009/0254805, Oct. 8, 2009 in class 715, sub-class 225; Publication Number 2011/0231325, Sep. 22, 2011 in class 705, sub-class 310; and Publication Number 2011/0239151, Sep. 29, 2011 in class 715, subclass 779.

### SUMMARY OF THE INVENTION

The subject invention provides for such a method distinguished by the combination of steps: operating a data processing center and establishing a link over the internet between an inventor and a patent agent both independent of the processing center, receiving at the processing center a payment via the internet from the inventor and acceptance of a contract between the inventor and the processing center in which the processing center agrees to provide a set of claims, receiving at the processing center via the internet from the inventor an invention disclosure including the results of any patentability search, accepting a contract between the processing center and a selected and independent patent agent to prepare a set of claims based upon the invention disclosure, receiving from the selected patent agent the set of claims and partial sections including the broad claim reciting a novel limitation after the coded phrase in the summary section with supporting old limitations before the coded phrase in the prior art section and the successive claims dependent on the broad claim with each dependent claim reciting a novel limitation and the independent picture claim containing all of the same verbiage used in the broad and dependent claims copied in the description section, providing the inventor an inventor-computer word processing program for applying a reference numeral to an element and automatically associating that reference numeral with all occurrences of the element in the description section and formatting the entire application to patent office requirements, and sending via the internet from the processing center the set of claims and partial sections in the inventor-computer word processing program to the inventor for completion using the inventor-computer word processing program.

### ADVANTAGES OF THE INVENTION

Thus several advantages of the invention provide potentially large savings in expenses to inventors to prepare and file a patent application, inventors who might not otherwise be able to afford the expense of a professional patent preparer. In order to assure quality patent applications, a processing center establishing a link over the internet between the inventor and a patent agent so that the inventor is assured of a quality patent application as the processing center selects only patent agents qualified by the United States Patent Office (USPTO) to prepare patent applications on behalf of inventors. The expense is reduced by the inventor participating in the final editing of the patent application structured by the patent agent. The processing center and the computer program structures the set of claims and partial sections of the patent application returned to the inventor to minimize or channel edits made by the inventor within boundaries to finish the application.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a patent preparation flow chart showing the steps used in the instant invention;

FIG. 2 is a block diagram showing the internet linkage between independent patent agents and inventors facilitated through the processing center of the subject invention;

FIG. 3 is a block diagram showing the steps of the subject invention operated through and by computers in the processing center of the subject invention;

FIG. 4 is a picture of the description section of this application with paragraphs copied from the picture claim and ready for editing by the inventor into grammatically correct sentence structure;

FIG. 5 is a picture of the beginning of the prior art section of this application with paragraphs copied from the sub-paragraphs preceding the coded phrase in the broadest claim and ready for editing by the inventor into grammatically correct sentence structure; and

FIG. 6 is a picture of the beginning of the summary section of this application with paragraphs copied from the sub-paragraphs following the coded phrase in the broadest claim and ready for editing by the inventor into grammatically correct sentence structure.

### DETAILED DESCRIPTION OF THE ENABLING EMBODIMENTS

Accordingly, this invention provides a method for an inventor and patent agent to collaborate in preparing a patent application. Although this description sets forth a series of steps, it is to be understood that the steps may be performed in any suitable order and/or grouped to be performed simultaneously.

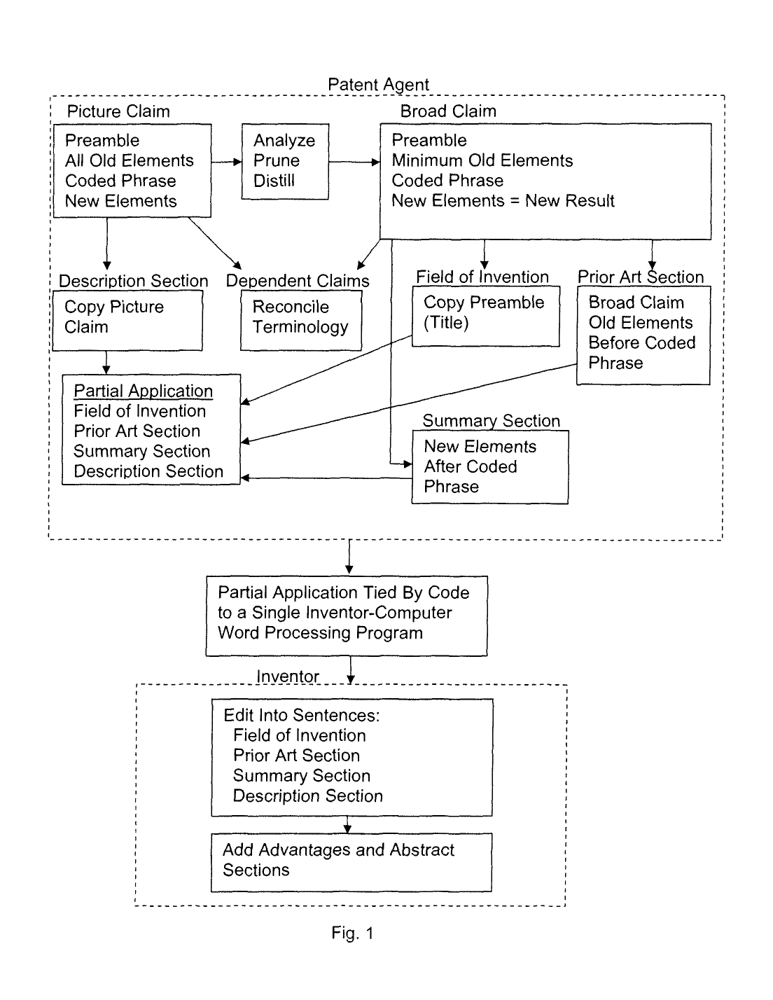

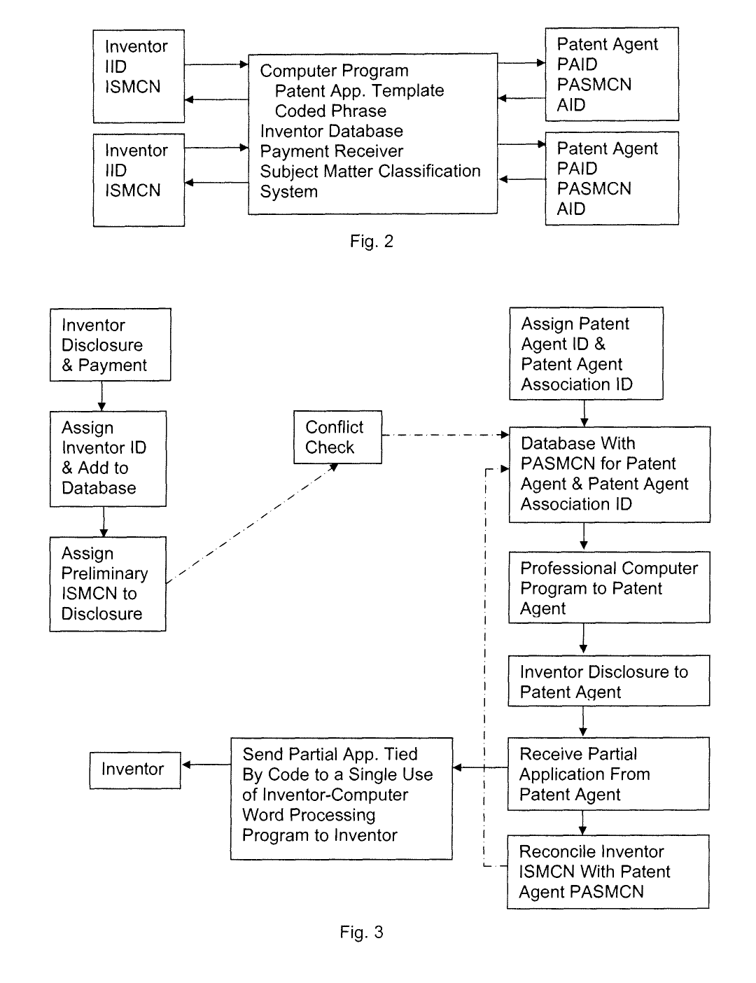

The initial patent application preparation steps to be performed by a patent agent are illustrated in FIG. 1.

The method includes imbedding a template setting forth sections of a patent application in a patent computer program including a Field of the Invention section, a prior art section designated Description of the Prior Art and a summary section designated SUMMARY OF THE INVENTION and a description designated DETAILED DESCRIPTION OF THE ENABLING EMBODIMENT and a claims section designated CLAIMS and equivalents thereof. The essence of the template and program is that, regardless of the headings or titles, the program formats a patent application with sections dedicated respectively to prior art of the type which would be listed in an information disclosure statement (IDS) required by the USPTO, a concise recitation of the novelty or patentable aspects of the invention, and that section which describes in detail the enabling embodiment of the invention.

The method also includes imbedding code in the computer program for recognizing the coded phrase “characterized by” and any portion thereof for identifying and moving limitations in subparagraphs of the independent broad claim into different sections of the template. Although the coded phrase “characterized by” is preferred because the phrase is used and known throughout the world, an equivalent phrase could be “the improvement comprising,” i.e., a Jepson format. Clearly, any phrase or portion (part or section thereof) could be coded as a marker between limitations in subparagraphs in the broad claim.

The method depends upon the patent agent drafting the claims in a particular structure or format so that in the end, the inventor edits and adds to an application containing total support for and copied from the claims prepared by the patent agent. More specifically, this step is distinguished by drafting a set of claims in the CLAIMS section of the template including a broad claim reciting a novel limitation in a subparagraph after the coded phrase characterized by with supporting old limitations in subparagraphs before the coded phrase characterized by and successive claims dependent on the broad claim with each dependent claim reciting a novel limitation and an independent picture claim containing in sub-paragraphs all of the same verbiage used in the broad and dependent claims. A code may be embedded in the computer program for automatically reconciling the preamble of the picture claim with the Field of the Invention.

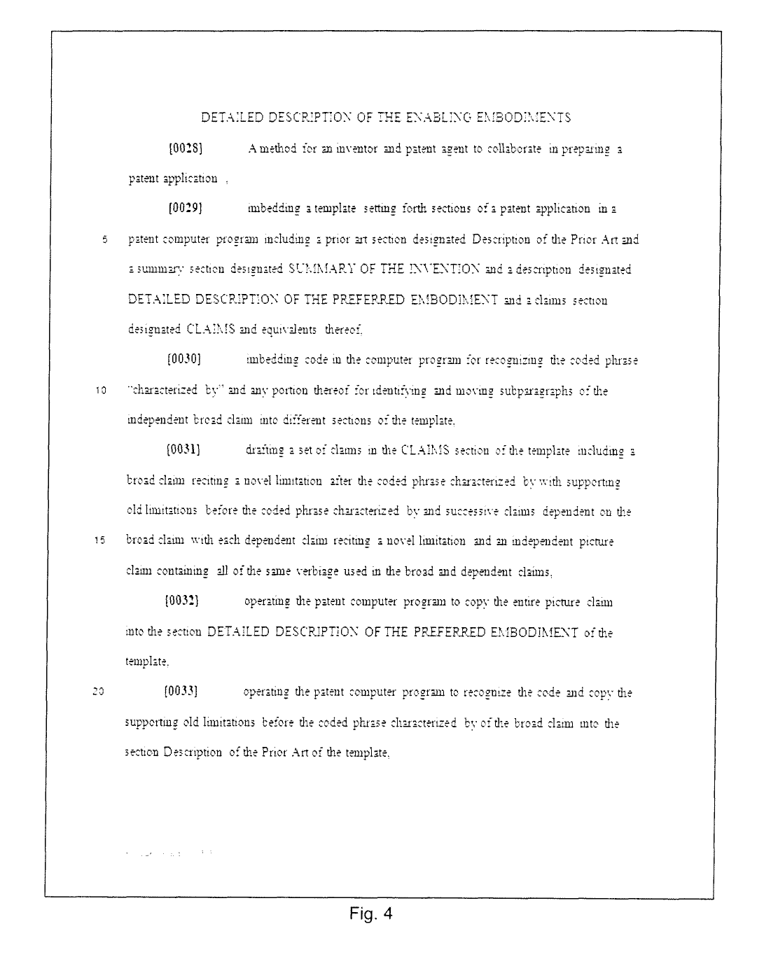

The patent computer program is operated by the patent agent to copy all of the sub-paragraphs of the picture claim into respective paragraphs in the description section DETAILED DESCRIPTION OF THE ENABLING EMBODIMENT of the template. It is very important that the picture claim indeed be a detailed word picture of the enabling embodiment and account for every element, feature and function of the enabling embodiment, i.e., it accounts for every line in the drawings. In order to base the description on the picture claim, the picture claim should be reconciled with the broad claim and dependent claims to make sure the picture claim contains all of the same verbiage used in the broad and dependent claims. In this manner every claim will find support in the same language in the description. Such a step in preparing the instant application is illustrated in FIG. 4 showing some of the paragraphs copied into the description section from the picture claim (the last independent claim). These paragraphs copied from the picture claim into the description section are ready for editing into grammatically correct sentence structure, and/or re-arranged into a more readable story while adding reference numerals referring to the drawing. Alternative terminology, embellishments, and environmental descriptions which fall under the umbrella of the broadest claim may be added.

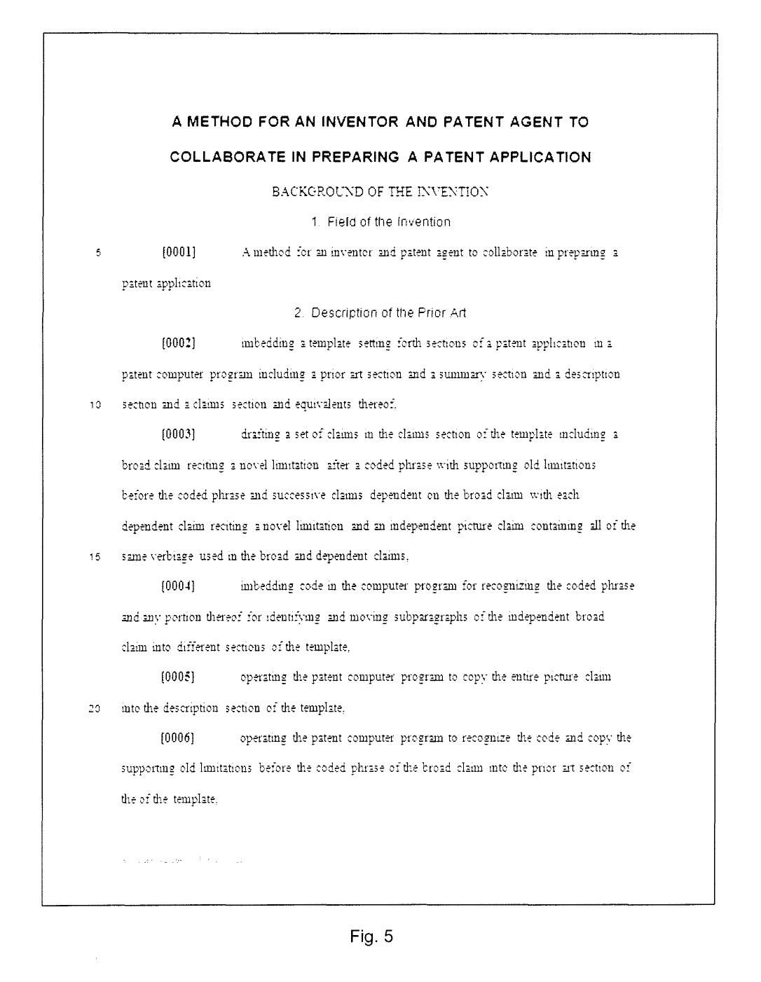

The method includes operating the patent computer program to recognize the code in the coded phrase and to copy the supporting old limitations in sub-paragraphs before the coded phrase of the broad claim into the section Description of the Prior Art of the template More specifically, the program recognizes the coded phrase “characterized by” and copies into the prior art section the old limitations in sub-paragraphs preceding the coded phrase “characterized by.” Such a step in preparing the instant application is illustrated in FIG. 5 showing some of the paragraphs copied into the prior art section from the broad claim (the first independent claim).

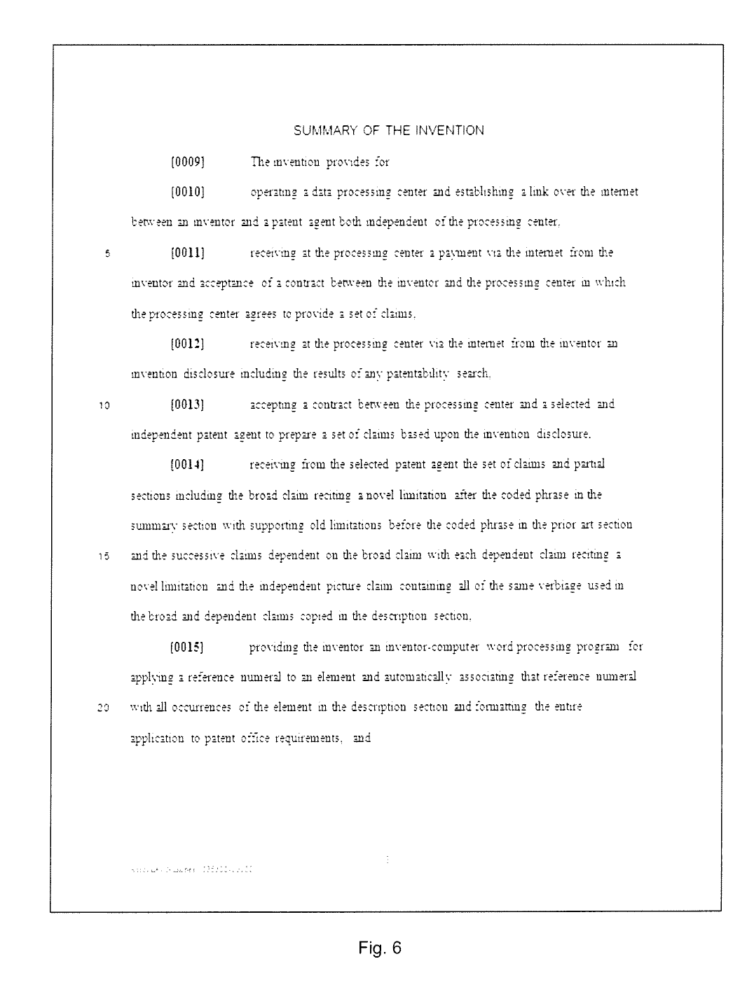

In a like fashion, the patent computer program is operated by the patent agent to recognize the coded phrase “characterized by” and copy a novel limitation after the coded phrase of the broad claim into the summary section SUMMARY OF THE INVENTION of the template. This step assures the summary section to be commensurate with the broadest scope of the invention, no broader or narrower in scope. In other words, this section of the application cannot be relied upon to change the interpretation of the broadest claim. Such a step in preparing the instant application is illustrated in FIG. 6 showing some of the paragraphs copied into the summary from the board claim (the first independent claim).

The method is characterized by a combination of steps to produce the new results set forth in the advantages section above. The invention includes the establishment of a data processing center to contact with inventors and independently contract with a patent agent to prepare a set of claims and patent applications sections based on the claims wherein the inventor participates in the preparation of the patent application by finalizing a draft of the application prepared by the patent agent and sent to the inventor by the processing center, but wherein that editing and finalizing by the inventor only requires grammatically correct sentence structure, re-arrangement, adding reference numerals, alternative terminology, embellishments, and/or environmental descriptions.

Accordingly, the method includes operating the data processing center and establishing a link over the internet between an inventor and an patent agent both independent of the processing center, i.e., the processing center, the inventor and the patent agent are all independent contractors relative to one another, whereby the processing center independently contracts with a number of different patent agents each to draft a set of claims for a particular inventor and the inventor would not know the identity of the patent agent contracted to draft a set of claims based upon the inventor's invention submitted to the processing center.

The patent computer program presenting the template with the sections of a patent application including professional and inventor versions for independent use by the patent agent and then the inventor is stored and/or controlled by the data processing center. The program maybe on a web-site and available for downloading. Therefore, the method includes storing and controlling the patent computer program with the data processing center. The processing center receives via the internet a request for a set of claims from an inventor. Usually the processing center simultaneously receives via the internet from the inventor an invention disclosure including the results of any patentability search. The patentability search results can merely be the prior art of which the inventor is aware, if any; all the way up to a professionally conducted prior art search. In response, the processing center assigns and associates an inventor identification (IID) to and with successive inventors, i.e., as the inventors are registered at the processing center. The processing center maintains an inventor data base on a computer by including a list of inventors with the associated inventor identification (IID). The processing center also contracts with the inventor and receives a consideration in the form of a payment via the internet from the inventor and acceptance of a contract between the inventor and the processing center in which the processing center agrees to provide a set of claims and access to a version of the patent computer program for use by the inventor for final editing of the application in consideration for the payment.

As is well known, patent offices around the world assign a subject matter classification number to each patent granted which reflects the technology to which the patent pertains. There is an international classification system and the USPTO maintains a classification system dividing all technology down into numbered classes and sub-classes with each defining a specific subject matter. The definitions for the respective classes and sub-classes indicate the subject matter to be found in and excluded from a class and sub-class. Accordingly, the processing center maintains and/or accesses a patent office classification system dividing technology by numbers into classes and sub-classes of technology and indicating the subject matter to be found in and excluded from a class and sub-class to enable the assigning of each invention disclosure received from an inventor an initial invention subject matter classification number (ISMCN) and storing the initial invention subject matter classification number (ISMCN) with the inventor identification (IID) in a computer at the processing center.

The processing center maintains a conflict data base on a computer by including the initial subject matter classification number (ISMCN) stored with each inventor identification (IID). The processing center also maintains a patent agent data base on a computer by the processing center including a patent agent identification (PAID) and an association identification (AID) for each patent agent to identify individual patent agents and to identify patent agents associated in and with the same business association. The same business association would be one where the patent agents comingle funds and/or have access to inventions disclosures and files for different inventors. This could be a group of patent agents as in a law firm, an association where one patent agent could not work on a set of claims which conflict in subject matter with a set of claims prepared by another patent agent in the same association. In this pursuit, the processing center inserts a patent agent subject matter classification number (PASMCN) with each patent agent identification in the patent agent data base for each set of claims prepared by that patent agent for the processing center and inserts an association subject matter classification number (SMCN) with each association identification (AID) in the patent agent data base for each set of claims prepared by every patent agent identification (PAID) in the same association (AID) of patent agents.

The method includes the processing center selecting a patent agent from the patent agent data base for processing the inventor disclosure and preparing the set of claims and conducting a conflict check for that selected patent agent. The processing center will establish a quality standard and/or criteria and will only select a patent agent meeting those criteria and standards, e.g., a patent agent proficient in the use of the computer program and adherence to its structure. The conflict check is conducted by scanning each patent agent identification (PAID) and each association identification (AID) in the patent agent data base for a match between the initial subject matter classification number (SMCN) of the invention disclosure and all of the subject matter classification numbers (SMCN) assigned to the patent agent and the patent agent's association (AID) to avoid a subject matter conflict between inventors, i.e., to avoid a conflict by a patent agent working on behalf of two inventors having the same invention.

This is followed by the processing center sending the invention disclosure with a request for a set of claims to the selected patent agent having no subject matter conflict. The processing center and the selected patent agent both accept a contract between them to prepare a set of claims based upon the invention disclosure, i.e., the patent agent agrees to prepare and deliver to the processing center a set of claims in consideration for payment by the processing center. More specifically, the selected patent agent contracts to deliver and does deliver to the processing center the set of claims along with partial sections of the patent application including the broad claim reciting a novel limitation after a characterized by clause in the summary section with supporting old limitations before the characterized by clause in the prior art section and the successive claims dependent on the broad claim with each dependent claim reciting a novel limitation and the independent picture claim containing all of the same verbiage used in the broad and dependent claims copied in the description section.

In addition, the patent agent contracts and delivers a patent-agent subject matter classification number (PASMCN), i.e., a subject matter classification number (SMCN) for the class and/or sub-class in which the patent agent believes the patent office would assign to the patent application upon grant of the patent. This requires reconciling the initial subject matter classification number (ISMCN) associated with each inventor identification (IID) by the processing center to agree with the patent agent subject matter classification number (PASMCN) from the patent agent.

As alluded to above, the method includes the processing center providing and sending to the inventor an inventor-computer word processing program including the set of claims and partial sections imbedded in the inventor-computer word processing program. The inventor uses the inventor-computer word processing program for completing the application by applying a reference numeral to an element and automatically associating that reference numeral with all occurrences of the element in the description section and formatting the entire application to patent office requirements, including automatically applying paragraph numbers in brackets to successive paragraphs. In addition, the inventor will draft the advantages and abstract sections of the application.

In addition, the method includes embedding a computer coded connection between the inventor-computer word processing program and the set of claims and partial sections sent to the inventor for preventing use of the inventor-computer word processing program with documents other than the sent set of claims and partial sections. In other words, the coded connection provides the inventor a license to use the inventor-computer word processing program for the single purpose of finalizing the partial application with which the program is transmitted to the inventor. The inventor-computer word processing program is only operable when the partial application has an embedded license. This prevents the inventor from using the inventor-computer word processing program with more than one patent application without obtaining a license. For example, the license to use the inventor-computer word processing program is tied to one or more of the number of claims, the words in the claims, the title, the inventor name, and the elements and if the claims change from the original licensed content, outside a certain set percentage, then the inventor-computer word processing program no longer works. In a specific example, the embedding a computer coded connection may be disable the use of the inventor-computer word processing program in response to the set of claims being deleted or changed more than a minor percentage, e.g., a five percent (5%) change in the claims. This function would also serve a quality control function to maintain the professionalism of the patent agent. If the inventor deemed a necessity to change the claims more than five percent, the inventor can request the processing center to have the patent agent review the subject matter of the requested changes. There is a tool available to create the license and embed it in the inventor-computer word processing program. The coded connection would also use encryption to prevent cracking.

On the other hand, the professional version of the computer program used by the patent agent may be purchased for use with multiple patent applications and includes many more operating options or functions.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. This separation of the new from the old by a coded phrase in the claims should not be interpreted as limiting the performance of the steps in any specific order, i.e., the steps may be performed in any order and/or simultaneously. In addition, the reference numerals in the claims are merely for convenience and are not to be read in any way as limiting.

1. A method for an inventor and patent agent to collaborate in preparing a patent application comprising;
imbedding a template setting forth sections of a patent application in a patent computer program including a prior art section and a summary section and a description section and a claims section,
drafting a set of claims in the claims section of the template including a first claim reciting at least one concluding limitation recited after a coded phrase “characterized by” and at least one supporting limitation recited before the coded phrase “characterized by” and successive claims dependent on the broad claim with each dependent claim reciting an additional limitation and an independent picture claim containing all of the same verbiage used in the broad and dependent claims,
imbedding code in the computer program for recognizing the coded phrase “characterized by” and the at least one concluding limitation and the at least one supporting limitation,
operating the patent computer program to copy the entire picture claim and paste only the entire picture claim into the description section of the template,
operating the patent computer program to recognize the coded phrase “characterized by” and copy the at least one supporting limitation recited before the coded phrase “characterized by” of the first claim and paste only the at least one supporting limitation into the prior art section of the template,
operating the patent computer program to recognize the coded phrase “characterized by” and copy the at least one concluding limitation recited after the coded phrase “characterized by” of the first claim and paste only the at least one concluding limitation into the summary section of the template,
operating a data processing center and establishing a link over the internet between an inventor and a patent agent both independent of the processing center,
receiving at the processing center a payment via the internet from the inventor and acceptance of a contract between the inventor and the processing center in which the processing center agrees to provide a set of claims and access to a version of the patent computer program for use by the inventor for final editing of the application,
receiving at the processing center via the internet an invention disclosure including the results of any patentability search from the inventor,
accepting a contract between the processing center and a selected and independent patent agent to prepare a set of claims based upon the invention disclosure,
receiving from the selected patent agent the set of claims including the first claim reciting the at least one concluding limitation recited after the coded phrase “characterized by” and the at least one supporting limitation recited before the coded phrase “characterized by” and the successive claims dependent on the first claim and the independent picture claim containing all of the same verbiage used in the first and dependent claims and partial sections of the patent application including the prior art section reciting the at least one supporting limitation and the summary section reciting the at least one concluding limitation and the description section reciting the independent picture claim,
providing the inventor an inventor-computer word processing program,
sending via the internet from the processing center the set of claims and partial sections of the patent application to the inventor for completion using the inventor-computer word processing program,
operating the inventor-computer word processing program by the inventor to apply a reference numeral to an element and automatically associate that reference numeral with all occurrences of the element in the description section and format the entire application to predetermined requirements, and
embedding a computer coded connection between the inventor-computer word processing program and the set of claims and partial sections of the patent application sent to the inventor for preventing use of the inventor-computer word processing program with documents other than the sent set of claims and partial sections of the patent application.

2. (canceled)

3. A method as set forth in claim 1 wherein the embedding a computer coded connection is further defined as disabling the use of the inventor-computer word processing program in response to the set of claims being changed more than a predetermined percentage.

4. A method for an inventor and patent agent to collaborate in preparing a patent application comprising;
imbedding a template setting forth sections of a patent application in a patent computer program including a prior art section and a summary section and a description section and a claims section,
drafting a set of claims in the claims section of the template including a first claim reciting at least one concluding limitation recited after a coded phrase “characterized by” and at least one supporting limitation recited before the coded phrase “characterized by” and successive claims dependent on the broad claim with each dependent claim reciting an additional limitation and an independent picture claim containing all of the same verbiage used in the first and dependent claims,
imbedding code in the computer program for recognizing the coded phrase “characterized by” and the at least one concluding limitation and the at least one supporting limitation,
operating the patent computer program to copy the entire picture claim and paste the entire picture claim into the description section of the template,
operating the patent computer program to recognize the coded phrase “characterized by” and copy the at least one supporting limitation recited before the coded phrase “characterized by” of the first claim and paste the at least one supporting limitation into the prior art section of the of the template,
operating the patent computer program to recognize the coded phrase “characterized by” and copy the at least one concluding limitation recited after the coded phrase “characterized by” of the first claim and paste the at least one concluding limitation into the summary section of the template,
operating a data processing center and establishing a link over the internet between an inventor and a patent agent both independent of the processing center,
receiving at the processing center a payment via the internet from the inventor and acceptance of a contract between the inventor and the processing center in which the processing center agrees to provide a set of claims and access to a version of the patent computer program for use by the inventor for final editing of the application,
receiving at the processing center via the internet an invention disclosure including the results of any patentability search from the inventor,
accepting a contract between the processing center and a selected and independent patent agent to prepare a set of claims based upon the invention disclosure,
receiving from the selected patent agent the set of claims including the first claim reciting the at least one concluding limitation recited after the coded phrase “characterized by” and the at least one supporting limitation recited before the coded phrase “characterized by” and the successive claims dependent on the first claim and the independent picture claim containing all of the same verbiage used in the first and dependent claims and partial sections of the patent application including the prior art section reciting only the at least one supporting limitation and the summary section reciting only the at least one concluding limitation and the description section reciting only the independent picture claim,
providing the inventor an inventor-computer word processing program,
sending via the internet from the processing center the set of claims and partial sections of the patent application to the inventor for completion using the inventor-computer word processing program,
operating the inventor-computer word processing program by the inventor to apply a reference numeral to an element and automatically associate that reference numeral with all occurrences of the element in the description section and format the entire application to predetermined requirements,
assigning each invention disclosure received from an inventor an initial subject matter classification number and storing the initial subject matter classification number with the inventor identification in the processing center,
accessing a patent office classification system dividing technology by numbers into classes and sub-classes of technology and indicating the subject matter to be found in and excluded from a class and sub-class,
maintaining a patent agent data base on a computer by the processing center to identify patent agents,
inserting a subject matter classification number with each patent agent in the patent agent data base for each set of claims prepared by that patent agent for the processing center, and
conducting a conflict check for a selected patent agent by scanning the patent agent data base for a match between the initial subject matter classification number of the invention disclosure and all of the subject matter classification numbers assigned to the patent agent to avoid a subject matter conflict between inventors.

5. A method as set forth in claim 4 further comprising;
receiving from the selected patent agent with the set of claims a patent-agent proposed subject matter classification number, and
reconciling the initial subject matter classification number associated with each inventor to agree with the patent agent subject matter classification number proposed from the patent agent.

6. A method as set forth in claim 4 further comprising;
maintaining an association identification for each patent agent in the patent agent data base to identify patent agents in and with the same business association,
selecting the patent agent from the patent agent data base for processing the inventor disclosure and preparing the set of claims,
inserting a subject matter classification number with each association identification in the patent agent data base for each set of claims prepared by every patent agent in the same association identification of patent agents,
conducting a conflict check for that selected patent agent by scanning the patent agent and association identifications in the patent agent data base for a match between the initial subject matter classification number of the invention disclosure and all of the subject matter classification numbers assigned to the patent agent identification and the patent agent's association identification to avoid a subject matter conflict between inventors, and
sending from the processing center the invention disclosure to the selected patent agent having no subject matter conflict with a request for a set of claims.

7. A method as set forth in claim 4 further comprising;
assigning and storing an inventor identification to and with successive inventors,
storing and controlling the patent computer program with the data processing center,
receiving at the processing center via the internet a request for a set of claims from an inventor,
maintaining an inventor data base on a computer by the processing center including a list of inventors and assigned inventor identification, and
maintaining a conflict data base on a computer by the processing center including the initial subject matter classification number stored with each inventor identification.

8. A method for an inventor and patent agent to collaborate in preparing a patent application comprising;
embedding a template setting forth sections of a patent application in a patent computer program including a prior art section designated Field of the Invention and Description of the Prior Art and a summary section designated SUMMARY OF THE INVENTION and a description section designated DETAILED DESCRIPTION OF THE ENABLING EMBODIMENT and a claims section designated CLAIMS,
embedding code in the computer program for recognizing the coded phrase “characterized by” and any portion thereof for identifying and moving limitations in subparagraphs of the independent broad claim into different sections of the template,
drafting a set of claims in the CLAIMS section of the template including a first broad claim reciting at least one supporting limitation recited in a subparagraph after the coded phrase “characterized by” and at least one concluding limitation recited in subparagraphs before the coded phrase “characterized by” and successive claims dependent on the first broad claim with each dependent claim reciting an additional limitation and an independent picture claim containing in subparagraphs all of the same verbiage used in the first broad and dependent claims,
embedding a code in the computer program for automatically reconciling the preamble of the picture claim with the Field of the Invention,
operating the patent computer program to copy all of the sub-paragraphs of the picture claim and paste only the sub paragraphs of the picture claim into respective paragraphs of the description section DETAILED DESCRIPTION OF THE ENABLING EMBODIMENT of the template,
operating the patent computer program to recognize the coded phrase “characterized by” and to copy the at least one supporting limitation recited before the coded phrase of the first broad claim and paste only the at least one supporting limitation into the section Description of the Prior Art of the template,
operating the patent computer program to recognize the coded phrase “characterized by” and copy the at least one concluding limitation recited after the coded phrase “characterized by” of the first broad claim and paste the at least one concluding limitation into the summary section SUMMARY OF THE INVENTION of the template,
operating a data processing center and establishing a link over the internet between an inventor and an patent agent both independent of the processing center,
storing and controlling the patent computer program with the data processing center,
receiving at the processing center via the internet a request for a set of claims from an inventor,
receiving at the processing center via the internet an invention disclosure including the results of any patentability search from the inventor,
assigning and storing an inventor identification to and with successive inventors,
maintaining an inventor data base on a computer by the processing center including a list of inventors with the associated inventor identification,
receiving at the processing center a payment via the internet from the inventor and acceptance of a contract between the inventor and the processing center in which the processing center agrees to provide a set of claims and access to a version of the patent computer program for use by the inventor for final editing of the application,
accessing a patent office classification system dividing technology by numbers into classes and sub-classes of technology and indicating the subject matter to be found in and excluded from a class and sub-class,
assigning each invention disclosure received from an inventor an initial subject matter classification number and storing the initial subject matter classification number with the inventor identification in a computer at the processing center,
maintaining a conflict data base on a computer by the processing center including the initial subject matter classification number associated with each inventor identification,
maintaining a patent agent data base on a computer by the processing center including a patent agent identification and an association identification for each patent agent to identify patent agents associated in and with the same business association,
inserting a subject matter classification number with each patent agent identification in the patent agent data base for each set of claims prepared by that patent agent for the processing center,
inserting a subject matter classification number with each association identification in the patent agent data base for each set of claims prepared by every patent agent identification in the same association of patent agents,
selecting a patent agent from the patent agent data base for processing the inventor disclosure and preparing the set of claims,
conducting a conflict check for that selected patent agent by scanning the patent agent identification and association identification in the patent agent data base for a match between the initial subject matter classification number of the invention disclosure and all of the patent agent subject matter classification numbers assigned to the patent agent and the patent agent's association to avoid a subject matter conflict between inventors,
sending from the processing center the invention disclosure to the selected patent agent having no subject matter conflict with a request for a set of claims,
accepting a contract between the processing center and the selected patent agent to prepare a set of claims based upon the invention disclosure,
receiving from the selected patent agent the set of claims including the first broad claim reciting the at least one concluding limitation recited after the coded phrase “characterized by” and the at least one supporting limitation recited before the coded phrase “characterized by” and the successive claims dependent on the first broad claim and the independent picture claim containing all of the same verbiage used in the first broad and dependent claims and partial sections of the patent application including the Description of the Prior Art section of the template reciting the at least one supporting limitation and the SUMMARY OF THE INVENTION section of the template reciting the at least one concluding limitation and the DETAILED DESCRIPTION OF THE ENABLING EMBODIMENT section of the template reciting the independent picture claim containing all of the same verbiage used in the broad and dependent claims and a patent agent subject matter classification number,
reconciling the initial subject matter classification number associated with each inventor identification to agree with the patent agent subject matter classification number from the patent agent,
providing the inventor an inventor-computer word processing program,
sending via the internet from the processing center the set of claims and partial sections of the patent application in and with the inventor-computer word processing program,
operating the inventor-computer word processing program by the inventor to apply a reference numeral to an element and automatically associate that reference numeral with all occurrences of the element in the description section and format the entire application to predetermined requirements and complete and draft the advantages and abstract sections,
embedding a computer coded connection between the inventor-computer word processing program and the set of claims and partial sections sent to the inventor for preventing use of the inventor-computer word processing program with documents other than the sent set of claims and partial sections of the patent application, and
the embedding a computer coded connection being further defined as disabling the use of the inventor-computer word processing program in response to the set of claims being changed more than a predetermined percentage.
